(19) United States
(12) Patent Application Publication
(10) Pub. No.: US 2002/0142125 A1
(43) Pub. Date: Oct. 3, 2002

(54) Disposable restroom floor mats

(76) Inventor: Galen Seal, Carlsbad, CA (US)

Correspondence Address: Steven W. Webb, Law Offices of Steven W. Webb, 655 Second Street, Encinitas, CA, 92024, US

(21) Appl. No.: 10/025,278

(22) Filed: Dec. 18, 2001

Related U.S. Application Data
(60) Provisional application No. 60/281,132, filed on Apr. 2, 2001.

(51) Int. Cl. B32B 3/02

(52) U.S. Cl. 428/81

(57) ABSTRACT

An improved restroom floor mat is presented, where the mat material is treated with a proprietary anti-microbial agent. The agent is refreshable with a water-based solution and makes the mat reusable for a limited number of times, maintaining its anti-microbial properties. An alternate embodiment is fully disposable, treated with the agent, and made out of low-cost blotter paper.

### RELATED U.S. APPLICATIONS

This application supplements and completes Provisional Application 60/281,132, filed Mar. 30, 2001.

### BACKGROUND OF THE INVENTION

This invention relates to mats that can be used to protect restroom floors from staining and decrease restroom odor. This invention can also be applied to mats placed at building entrances, high-traffic areas, cafeterias, and the like.

Restroom floors, particularly in men's rooms, are difficult to keep clean, dry, and odor-free. As a result, the floor surfaces around stools and urinals are frequently left wet with urine for days, or weeks.

Public facilities in service stations, theaters, stadiums, office buildings, restaurants, even airline restrooms are often neglected because the floors require mopping, scrubbing, and disinfecting. This is a distasteful and time-consuming job, and cleaning employees often avoid this task. The result is a breeding-ground for bacteria and the resulting offensive odors. Neglect of the stained areas results in permanent staining around stools and urinals.

There are many protective floor mats in the relevant art. The available art can be broken down into two main categories: disposable paper-like protection or relatively expensive semi-permanent mats. The durable mats are usually woven or nonwoven with impermeable backing to prevent liquids from seeping through. The disposable mats are made of paper-like substances and are porous, usually backed with an impermeable backing.

Typical of these types of floor mats are U.S. Pat. No. 4,609,580, a disposable floor mat that can have an extended life-time, made of woven nylon filament, and U.S. Pat. No. 4,125,656, which is a paper based, disposable skirt for the base of a toilet. Several other patents exist which embody these general characteristics.

### BRIEF SUMMARY OF THE INVENTION

The purpose of this product is to prevent or substantially reduce restroom odors, floor staining, and the spread of bacteria, viruses, fungi, molds, and yeasts through foot traffic. The product will be produced in two basic applications: 1) a disposable product that would be replaced daily, and 2) a disposable product that has a several-day to several-week life-cycle.

The floor mat designed to be replaced daily would be absorbent paper product, similar to heavy-weight desk blotters or drink coasters. The weight of this material would vary from 80 pound (16 point) to 190 pound (50 point).

The floor mat for use over several days or weeks would have a face material of non-woven polypropolene or non-woven polyester fiber, or some other synthetic fiber. The face material would have a face weight of 3 ½ ounces to 20 ounces per square yard.

Both the absorbent paper and the synthetic fiber face materials would have the ability to absorb, trap or disperse liquids within the face material. Both embodiments of this invention would have underlayers that are nonslip, moisture barriers that prevent curling of the invention while in place.

The underlayers can vary from films to coatings. The film would adhere to the facing with water-resistent adhesive. The coatings would be air-dried or heat-cured materials. A typical underlayer would be mechanically-frothed polyurethane foam.

The underlayers are designed to prevent urine and other liquids from staining tile and vinyl floors. The underlayer also prevents the floor mats from slipping and sliding on smooth floors.

These products will be treated with an anti-microbial medium, which will allow the mats to be used for several days to weeks before requiring disposal. The medium can be applied by spray or by adding the compound to the manufacturing process. Available anti-microbial agents are: 1) aldehyde, 2) alcohols, 3) quaternary ammonium, 4) heavy metals, 5) phenolics, 6) chlorhexidine, 7) peroxides/oxygenators, and 8) halogens.

Preliminary implementations of the invention show that N-halogen chlorines are the most effective anti-microbials. This is a proprietary product of Halosource Corp. The product can be refreshed in the mats by spraying with a water-based solution, so that the mats can be reused. This product meet EPA guidelines so that the mats can be disposed of using ordinary waste management facilities.

It is an object of this invention to provide low-cost manufacture restroom sanitary mats.

It is an object of this invention to provide the mats in a daily disposable or long-term use mode.

It is an object of this invention to provide the mats in several shapes to fit applications in a variety of locations.

It is a further object of this invention to provide the mats with an effective, multiple-refresh antimicrobial agent.

Further objects of this invention can be discerned by perusing the detailed description, drawings, specifications and claims of this application.

### BRIEF DESCRIPTION OF THE DRAWINGS

The construction and operation of the invention can be readily appreciated from inspection of the drawings that accompany this application, combined with the detailed specification to follow.

FIG. 1 is a perspective drawing of the preferred embodiment of the invention used with a urinal.

FIG. 2 is a perspective drawing of the preferred embodiment of the invention used with a toilet.

FIG. 3 is a top view diagram showing how the shape of the preferred embodiment.

FIG. 4 is a side view of the disposable embodiment.

FIG. 5 is top view of the re-usable embodiment, showing the two layers.

FIG. 6 is a side view of the re-usable embodiment, showing the two layers.

### DETAILED DESCRIPTION OF THE INVENTION

The invention is best described by referring to the preferred embodiment illustrated in the drawings in FIGS. 5 and 6.

Referring to FIG. 4, a disposable restroom floor mat ¹⁰¹ is a flat piece of absorbent material, comprised of two layers of material. The face material ¹⁰² is glued or fixedly attached to the under layer ¹⁰³. In the preferred embodiment, the face material is non-woven polypropolene or non-woven polyester fiber. In the preferred embodiment, the underlayer is mechanically-frothed polyurethane foam. The face layer will be treated by a anti-bacterial agent, preferably N-halogen chlorine, a product of Halosource.

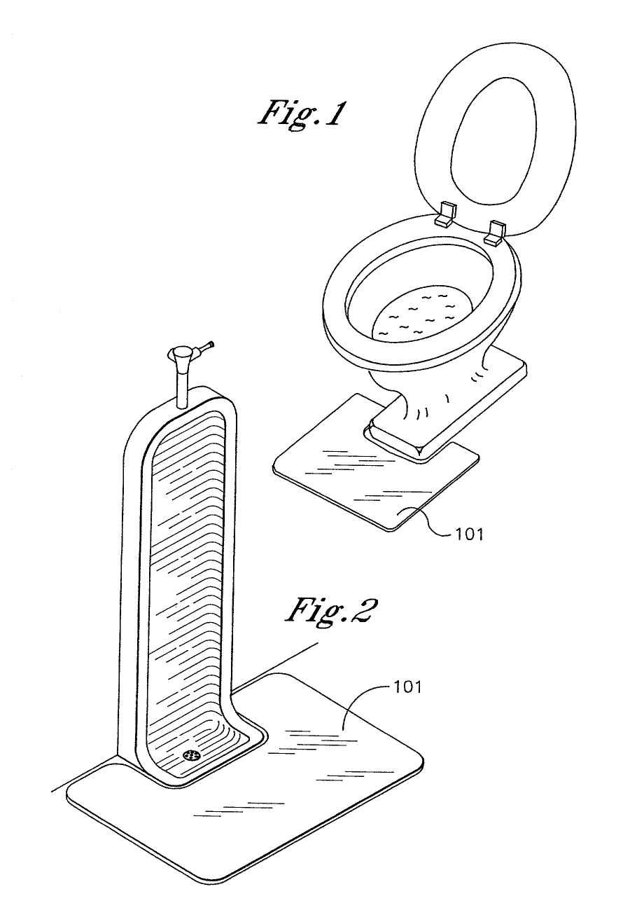

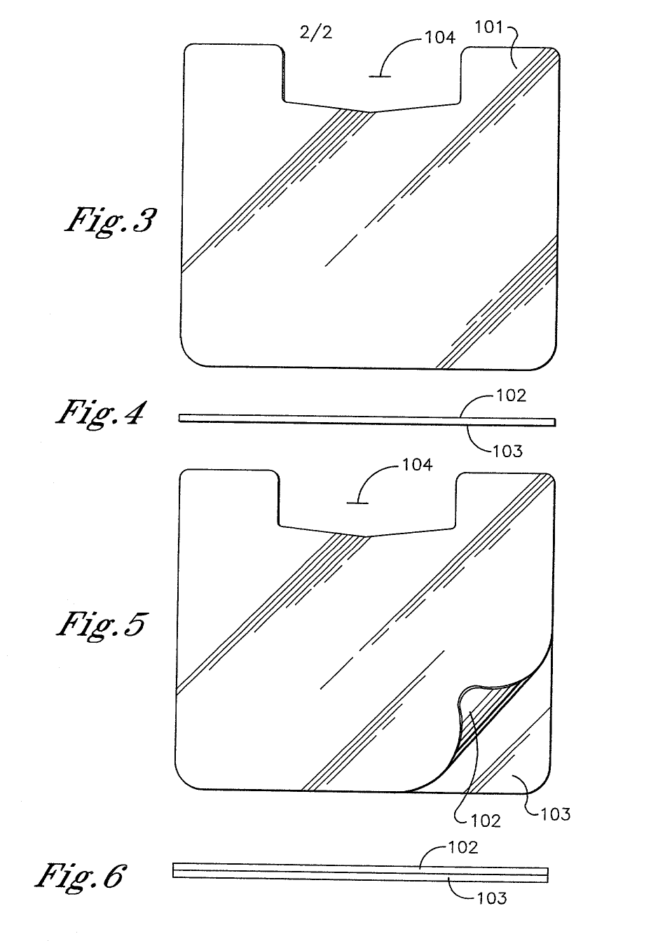

The shape of the preferred embodiment is shown in FIGS. 1, 2, 3 and 4. There is a characteristic notch in the flat material ¹⁰⁴ that fits the front of most toilet stool bases. Other notch shapes are possible in other embodiments. An instantiation of the mat with no notch, the mat shaped in a rectangle, is also included in this invention. A full-floor covering mat, such as an airliner restroom floor covering, is also included.

An alternate embodiment of the invention is shown in FIG. 4, where the face material is a heavy-weight, absorbent paper product ¹⁰², similar to blotter material. The underlayer would be sprayed on a very thin coating ¹⁰³. The underlayer would be thick enough to prevent liquids from passing through the face material to the floor. The face material ¹⁰² would also be treated with the N-halogen chlorine anti-microbial agent.

While the foregoing describes a preferred embodiment and an alternate embodiment, variation on this design and equivalent designs may be resorted to in the scope and spirit of the claimed invention.

what is claimed is:

1. A disposable floor mat for restroom floors and other high-maintenance areas requiring sanitation, the mat comprised of a flat face layer and a flat underlayer, the face layer fixedly attached to the underlayer,
the face layer comprised of synthetic fiber,
the underlayer comprised of non-slip, moisture-resistant, anti-curl film.

2. A mat as in claim 1, wherein the face material is comprised of absorbent paper material and wherein the underlayer is comprised of a thin coating that is non-slip, moisture-resistant, and anti-curl.

3. A mat as in claim 1 wherein the face material is treated with an antimicrobial agent.

4. A mat as in claim 2 wherein the face material is treated with an antimicrobial agent.

5. A mat as in claim 1 wherein the mat has a notch cut in one side that fits around the front of the base of a typical toilet stool.

6. A mat as in claim 1 wherein the mat is in a roughly rectangular shape large enough to fit under a typical urinal.

7. A mat as in claim 1, wherein the mat is sized to cover an entire restroom floor, or a substantial sub-portion thereof.
